(19) United States
(12) Patent Application Publication
(10) Pub. No.: US 2026/0100023 A1
(43) Pub. Date: Apr. 9, 2026

(54) MODULAR MACHINE LEARNING MODELS

(71) Applicant: HEWLETT PACKARD ENTERPRISE DEVELOPMENT LP, Spring, TX (US)

(72) Inventor: Sathyanarayanan Manamohan, Bangalore (IN)

(21) Appl. No.: 18/966,987

(22) Filed: Dec. 3, 2024

(30) Foreign Application Priority Data
Oct. 8, 2024 (IN) 202441076406

(51) Int. Cl. G06V 10/764; G06V 10/75; G06V 10/82

(52) U.S. Cl. CPC G06V 10/764; G06V 10/751; G06V 10/82

(57) ABSTRACT

Systems and methods are provided for generating modular, more explainable machine learning data structures. The system can comprise two main phases, including setting up the system during a constructing phase and utilizing the system during an inference/prediction phase. During the constructing phase, the system may generate an ontology that identifies features and structural constraints of the features, as well as a superclass based on the ontology. During the inference/prediction phase, a new input image is received and compared with features and constraints defined in the ontology. Based on the comparison, the system can generate an identification of the superclass for the new input image, explain why the input corresponds with the superclass, identify any features that are missing in order for the input to correspond with the superclass, and provide the explanation and input to a display/interface.

### BACKGROUND

Traditional deep neural network (DNN) and other machine learning (ML) models have made great strides in variety of classification tasks. They are increasingly used in various applications like autonomous driving, image synthesis, deep fake detection, and healthcare for making high stake decisions. As these models grow in popularity and use, the ML models themselves are increasingly scrutinized because of their potential impact on our way of life, much like the path of traditional software decades ago.

### BRIEF DESCRIPTION OF THE DRAWINGS

The present disclosure, in accordance with one or more various examples, is described in detail with reference to the following figures. The figures are provided for purposes of illustration only and merely depict typical, non-limiting aspects of such examples.

FIG. 1 illustrates a computing component for generating modular machine learning models, in accordance with some examples described herein.

FIG. 2 illustrates various types of machine learning models, in accordance with some examples described herein.

FIG. 3 illustrates a correlation between a specification and ontology, in accordance with some examples described herein.

FIG. 4 is an example computing component that may be used to implement various features discussed herein.

FIG. 5 is a computing component that may be used to implement examples of the disclosed technology.

The figures are not exhaustive and do not limit the present disclosure to the precise form disclosed.

### DETAILED DESCRIPTION

In general, ML models consist of layers of nodes, including an input layer, one or more hidden layers, and an output layer (hereinafter “a set of layers”). Each node connects to other nodes through an associated weight and threshold. If the output of any individual node is above the specified threshold value, that node may be activated and send data to the next layer of the network. Otherwise, no data is passed along to the next layer of the network. The data that progresses through the set of layers to the output layer can affect the final prediction/determination.

To train these models, the system can receive inputs and produce outputs based on a training process that is data-driven. In some examples, the input is transformed, based on the training of the set of hidden layers of nodes/neurons and weights, into an output/prediction value. The use of the hidden layers can reduce the visibility into the computational process and increase the efficiency of model. Yet, the use of the hidden layers can also reduce the availability to fix any errors or programmatically confirm results generated by the model. In this sense, the data-driven approach converts the trained model into monolithic black box that can simply receive the inputs and produce the outputs without a view into the processing. Users who rely on the trained model may find it difficult to comprehend the black box that is used to map the input to a specific output.

Examples of the current disclosure enable large ML models to be converted to a modular and more explainable structure. In some examples, the ML models may be pre-trained as they are received by the system or trained separately by the system from the described process. The system can comprise two main phases, including setting up the system during a constructing phase and utilizing the system during an inference/prediction phase. In some examples, the ML models may built and integrated in a modular manner using design specifications.

During the constructing phase, the system may generate an ontology that identifies features and corresponding structural constraints of the features. In some examples, the ontology is generated during the constructing phase using a reasoner. The ontology may be provided to a solver, which determines a superclass based on the ontology (e.g., a larger grouping of several smaller groups/clusters, like the eyes, nose, and mouth of a face that are grouped together to form a whole face). In other words, the solver may identify the superclass of the ontology given the set of features and structural constraints in the ontology. The system may also identify one or more neural networks or other machine learning models that are trained to determine the particular features from the ontology in a new input image.

In some examples, the solver receives the ontology as input and generates a textual/description statement or world view using description logic. The description logic may comprise various formats, including general, spatial, temporal, spatiotemporal, and fuzzy description logics, and each description logic is a different balance between expressive power and reasoning complexity by supporting different sets of mathematical constructors. In this example, the solver may review the symbols defined in the ontology and determine whether any deductions can be made, with the goal of providing the level/detail of the predictions that could have been generated from the full set of features.

In some examples, pre-trained neural networks or other machine learning models may be selected during the constructing phase to extract the particular symbols defined in the ontology. The models may be trained to detect/extract the particular symbol from the input. The extracted symbols may be used by the reasoners or solver later in the process (e.g., during the inference/prediction phase) to detect the symbols in new input/images.

During the inference/prediction phase, the new input image is received and passed to the identified neural networks or other machine learning models to generate an output from each model. The output from each model is provided to a filter that identifies the features in each output. The features from the filter are provided to the solver. The solver compares the features identified in the input with the features and corresponding structural constraints of the features that are required by the ontology (e.g., a particular superclass needs three features, are the features and structural constraints identified?). Based on the comparison, the system passes the findings to an explainer module. The explainer module can provide an identification of the superclass, explain why the input corresponds with the superclass, identify any features that are missing in order for the input to correspond with the superclass, and provide the explanation and input to a display/interface.

The output can include an explanation of the prediction. The explanation can be generated by a reasoner engine to produce verifiable proof of the model's classifications (e.g., OWL 2 Reasoner, HermiT, FaCT++, Pellet, etc.). For example, the reasoner engine can generate textual explanations for the output and provide an explainability for the model.

Technical improvements are described throughout the disclosure. For example, the system may reduce the processing load of a GPU by splitting a classification process/model into smaller pieces which can run on different processors (e.g., GPU, CPU) to reduce the load on a single processor. In some examples, the system may execute the processes described herein in sequence (e.g., sequentially) by separating the portions of the processing that are provided to the solver. The entire matrix or other output may not be provided to the reasoner at one time. In some examples, the reasoner may be executed by a CPU that runs separately and distinctly from processing executed by the GPU. In this way, the system described herein may be executed on both CPU and GPU, to utilize capabilities of each processor to run the same model, rather than relying on a single GPU to execute the model.

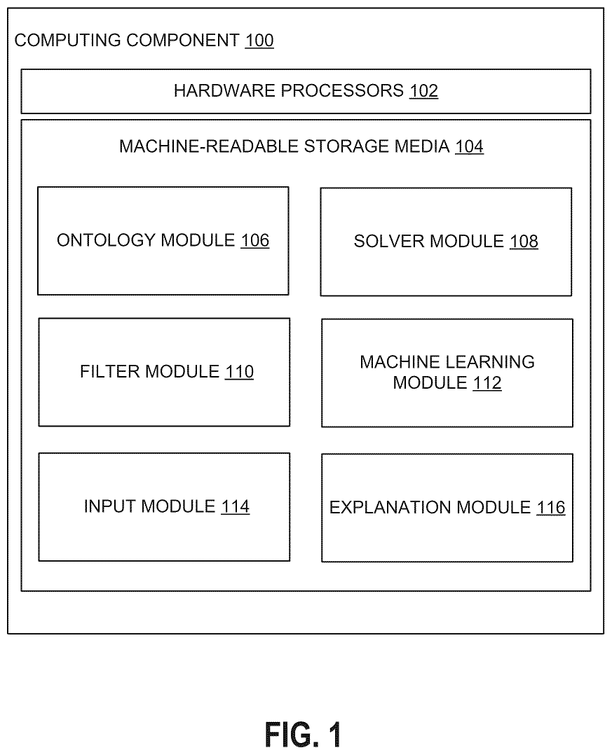

FIG. 1 illustrates a computing component for generating modular machine learning models, in accordance with some examples described herein. Computing component 100 is illustrated. Computing component 100 may be, for example, a server computer, a controller, or any other similar computing component capable of processing data.

Computing component 100 may communicate with other devices in a network, including devices at remote geographical sites. The network may be a public or private network, such as the Internet, or other communication network to allow connectivity among various the sites. The network may include third-party telecommunication lines, such as phone lines, broadcast coaxial cable, fiber optic cables, satellite communications, cellular communications, and the like, and may include any number of intermediate network devices, such as switches, routers, gateways, servers, and/or controllers.

Computing component 100 is configured to generate, train, and utilize a machine learning model for inference tasks, where the training or inference tasks may be implemented at multiple client devices from remote geographical sites. Computing component 100 is also configured to comprise two main phases, including setting up the system during a constructing phase and utilizing the system during an inference/prediction phase. In any of these examples, computing component 100 can receive input images for the training, constructing process, or the inference process, and generate a textual description of the same.

Computing component 100 includes hardware processor 102 and machine-readable storage medium 104. Machine-readable storage medium may comprise various modules configured with machine-readable instructions executed by processor 102, including ontology module 106, solver module 108, filter module 110, machine learning module 112, input module 114, and explanation module 116.

Hardware processor 102 may be one or more central processing units (CPUs), graphics processing units (GPUs), semiconductor-based microprocessors, and/or other hardware devices suitable for retrieval and execution of instructions stored in machine-readable storage medium 104. Hardware processor 102 may fetch, decode, and execute instructions to control processes or operations associated with the various modules illustrated herein. As an alternative or in addition to retrieving and executing instructions, hardware processor 102 may include one or more electronic circuits that include electronic components for performing the functionality of one or more instructions, such as a field programmable gate array (FPGA), application specific integrated circuit (ASIC), or other electronic circuits.

Machine-readable storage medium 104, may be any electronic, magnetic, optical, or other physical storage device that contains or stores executable instructions. Thus, machine-readable storage medium 104 may be, for example, Random Access Memory (RAM), non-volatile RAM (NVRAM), an Electrically Erasable Programmable Read-Only Memory (EEPROM), a storage device, an optical disc, and the like. In some examples, machine-readable storage medium 104 may be a non-transitory storage medium, where the term “non-transitory” does not encompass transitory propagating signals.

Ontology module 106 is configured to generate an ontology. The ontology may correspond with a computational form of data representation that is based on description logic. The ontology can quantize objects and their relationships, along with a set of constraints that limit the components of the ontology in a particular classification. Constraints may define different types of limitations and boundaries for the ontology, including test constraints, numeric constraints, and position constraints, and may also include relationships between the features. As an illustrative example, a classification of a face may define eyes, nose, and mouth, and the constraints may define that the face comprises only two eyes, only one nose, only two lips, and an expected location of these objects in relation to each other. When the input fails to include these features and locations, it may not correspond with the classification of the ontology.

The ontology may establish a set of symbols that are grounded to data. In some examples, the ontology may be manually generated to help ensure that it is conforming to the intended specification. By manually generating the ontology, the system can also facilitate debugging and correcting it for errors. It can also enable formal reviews further enhance trust and avoid biases by excluding paths that lead to inappropriate outcomes. In some examples, the ontology may not use automatic knowledge-based construction methods to build the ontology from datasets, since there may be a possibility of transferring unwanted behaviors (e.g., biases) from the dataset into the ontology.

In some examples, the ontology is stored as a graph data structure that utilizes nodes and edges. The data structure and components of the ontology may be limited to prevent it from making predictions on out-of-distribution inputs. Since the ontology is constructed manually, in some examples, it may use concepts that are easily understandable and can create computer-generated output that can form human-understandable concepts.

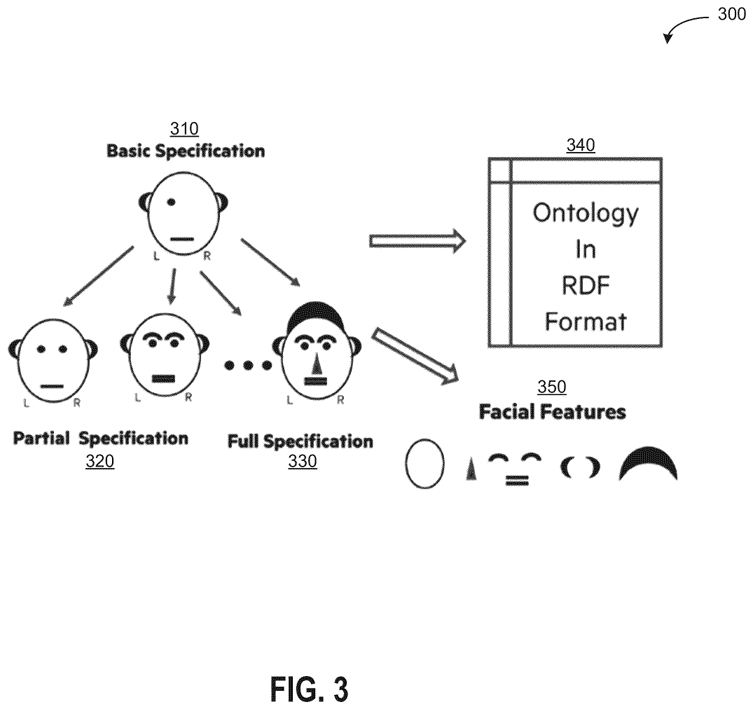

Ontology module 106 is also configured to generate the ontology from a specification. The specification may comprise features of a classification that help define terminology and the boundaries of the domain in a structured way. Additional information on an illustrative specification is provided with FIG. 3.

Solver module 108 is configured to receive an ontology generated by ontology module 106 and determine a superclass of the features and the structural constraints corresponding with the ontology. For example, the input to solver module 108 may be analyzed to determine whether the features defined in the ontology are present in the input. Solver module 108 may determine whether or not the feature is identifiable in the input and at the particular location defined in the constraint (or other defined constraints/rules in the ontology). Then, solver module 108 may use the information to determine the inference.

In some examples, solver module 108 receives the ontology as input and generates a description statement or description logic. The description logic may comprise various formats, including general, spatial, temporal, spatiotemporal, and fuzzy description logics, and each description logic is a different balance between expressive power and reasoning complexity by supporting different sets of mathematical constructors. In this example, solver module 108 may review the symbols defined in the ontology and determine whether any deductions can be made, with the goal of providing the level/detail of the predictions that could have been generated from the full set of features.

In some examples, solver module 108 uses the ontology to determine which symbols comply with the ontology. Once the ontology is configured, the superclass can be provided to other portions of the system to generate a prediction as well as the explanation (e.g., by explanation module 116).

In some examples, solver module 108 may use description logic where the system will receive symbols from the ontology and attempt to prove the ontology false. If the process cannot prove it, solver module 108 may determine that the ontology with the symbols is true and the symbols are consistent with the ontology. When the ontology is proven true, the input that is provided to the ontology to identify the superclass may accurately label the input.

Filter module 110 is configured to receive the output from machine learning module 112 and identify the symbols detected by the model. The detected symbols may correspond with detected portions in an input file that correspond with known features of a superclass. For example, the symbols in a superclass “face” may include eyes, nose, mouth, etc. or other defined classifications. The symbol itself is representation of activations for a given set of neurons in a classification machine learning model.

Filter module 110 is also configured to identify the features in each output during an interference phase. For example, the output from the ML model is provided to filter module 110 that identifies the features in each output. The features from the filter are provided to solver module 108, which compares the features identified in the input with the features and corresponding structural constraints of the features that are required by the ontology (e.g., a particular superclass needs three features, are the features and structural constraints identified?).

In some examples, more than one machine learning model is implemented. In this case, filter module 110 may estimate the same feature with different confidence values and select one of the confidence values from the available options. Filter module 110 may help determine the best model out of the applicable models and pass those features with the extracted attributes to solver module 108. Solver module 108 may determine whether the necessary features and constraints identified for the superclass are available in the input.

In some examples, filter module 110 determines which processor to direct the classification task and initiate execution of the machine readable instructions. For example, both CPU and GPU resources may be available for executing processing tasks. In traditional systems, the machine learning model may be exclusively executed on a GPU and the CPU may remain idle after it transmits an execution instruction to the GPU. In some examples, the GPU may be implemented as a peripheral device that is accessible via a bus that carries the instruction from the CPU to the GPU. In this instance, the processing relating to constructing the machine learning model and using the model for inference tasks can be executed by the GPU, which is directed by the CPU (e.g., via filter module 110). In some examples, ontology module 106, solver module 108, and filter module 110 may be executed on the CPU to save processing capabilities and bandwidth for the GPU.

Machine learning module 112 is configured to implement a machine learning model. The machine learning model may include layers of nodes, including an input layer, one or more hidden layers, and an output layer (hereinafter “a set of layers”). Each node connects to other nodes through an associated weight and threshold. If the output of any individual node is above the specified threshold value, that node may be activated and send data to the next layer of the network. Otherwise, no data is passed along to the next layer of the network. The data that progresses through the set of layers to the output layer can affect the final prediction/determination.

Machine learning module 112 may be trained during a training phase and the trained model may be implemented during an inference phase (e.g., to classify input based on the training). To train these models, the system can receive inputs and produce outputs based on a training process that is data-driven. In some examples, the input is transformed, based on the training of the set of hidden layers of nodes/neurons and weights, into an output/prediction value. The use of the hidden layers can reduce the visibility into the computational process and increase the efficiency of model.

The machine learning model may be trained to implement a classification task. A Classification task involves assigning one or more labels to the given data point (e.g., text, image, video, audio, records, etc.) that can classify or group the input into a class of similar input during an inference phase that is learned through a training phase.

Machine learning module 112 may implement a constructing phase. The training and construction of the model may be implemented with the classification process or as separate processes. The constructing phase may comprise, for example, generating an ontology that identifies a set of features and corresponding structural constraints of the features, determining, by a solver, a superclass given the set of features and corresponding structural constraints in the ontology, and identifying a machine learning model that is trained in identifying the set of features in a new input image.

In some examples, during the constructing phase, the system may generate an ontology that identifies features and corresponding structural constraints of the features. The ontology may be provided to a solver, which determines a superclass based on the ontology. In other words, the solver may identify the superclass given the set of features and structural constraints in the ontology. The system may also identify one or more neural networks or other machine learning models that are trained to determine the particular features from the ontology in a new input image.

Machine learning module 112 is also configured to identify pre-trained neural networks or other machine learning models to extract the particular symbols defined in the ontology (e.g., during the constructing phase). The models may be trained to detect/extract the particular symbol from the input. The extracted symbols may be used by the reasoners or solver later in the process (e.g., during the inference/prediction phase) to detect the symbols in new input/images.

Inference may be implemented by machine learning module 112 during an inference process. The inference process may comprise, for example, receiving the new input image and providing the providing the new input image to the machine learning model for generating an output. The output may be provided to a filter that identifies second features in the output, the second features may be provided to the solver associated with the constructing phase of the classification process. Using the solver, the second features may be compared with the set of features and corresponding structural constraints that are required by the ontology. Based on the comparison, the inference process may determine that the new input image corresponds with the superclass and in response to the constructing phase and the inference phase of the classification process, the system may provide a textual explanation of the superclass to an interface of the computer system.

Various machine learning models may be trained, constructed, or used for inference purposes. For example, the machine learning models described herein may comprise neural networks and deep learning models, including feedforward neural networks, convolutional neural networks (CNNs), or recurrent neural networks (RNNs).

Input module 114 may comprise any file type that is provided as input to a machine learning model. The input may comprise, for example, text, image, video, audio, records, and so on. The input may be received via a communication network.

Explanation module 116 is configured to generate a textual explanation for the output of the machine learning model (e.g., an explanation of the prediction). Explanation module 116 may correspond with a reasoner (e.g., OWL 2 Reasoners like FaCT++, HermiT, or Pellet, or a set of DL-safe rules, queries, description graphs, etc.) or other device that can produce verifiable proof of the model's classifications. In some examples, the textual explanations may be combined with perception models to generate additional descriptions about the behavior of the model.

For example, filter module 110 identifies features in the output of the ML model and provides the features to solver module 108. The solver compares the features and corresponding structural constraints of the features that are required by the ontology. Based on the comparison, the system passes the findings to explanation module 116 to generate the textual explanation for the output. In some examples, explanation module 116 is configured to provide an identification of the superclass, explain why the input corresponds with the superclass, identify any features that are missing in order for the input to correspond with the superclass, and provide the explanation and input to a display/interface.

In some examples, explanation module 116 uses the ontology to define mathematical terms of the specification of the model (e.g., using grounded symbols) and generate a verifiable proof of the classification that the model produced. This link between the stages may be used to generate explainability for the model. The machine learning model can help extract grounded symbols from unstructured data and utilize explanation module 116 to understand the concept grounding better.

In some examples, explanation module 116 may generate data used for additional technical benefits (e.g., in response to the generation of the classification of the input). For example, the link between the ontology, specification, and classification output can also allow system administrators to debug and correct the ontology in the event of errors. It also helps avoid biases by excluding paths in the ontology that lead to inappropriate outcomes and can limit the knowledge that ontology has to ensure it cannot produce predictions to out of distribution inputs.

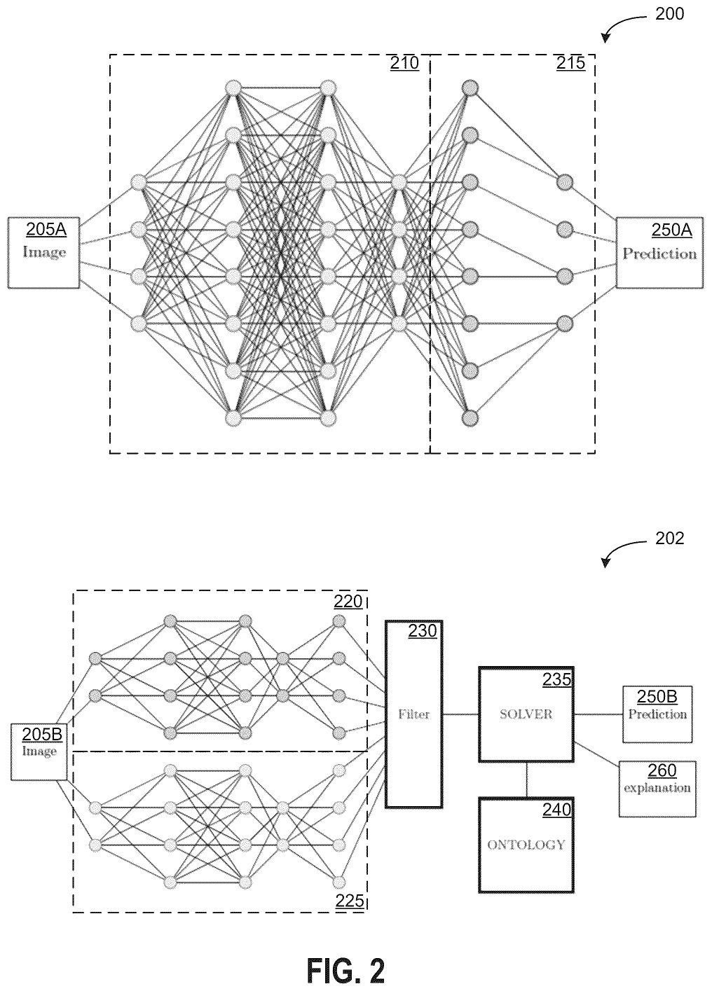

FIG. 2 illustrates various types of machine learning models, in accordance with some examples described herein. In examples 200, 202, illustrations are provided for machine learning models (e.g., DNN, etc.) that are trained to conduct a classification task, yet any task may be implemented without diverting from the essence of the disclosure. Both examples 200, 202 are initiated with input 205 (illustrated as first input 205A and second input 205B). In some examples, the same input may be received in each example 200, 202.

In example 200, the machine learning model comprises input 205A (illustrated as an image of the classification), hidden nodes 210, 215, and output 250A (illustrated as a prediction of the classification). Input 205A may comprise, for example, text, image, video, audio, records, and so on.

Hidden nodes 210, 215 may act as hidden layers in the ML model to transform the input data through a series of weighted connections and activation functions. Hidden nodes 210, 215 may enable the model to learn the symbols and relationships in the data by combining and refining the features extracted by the input layer. In some examples, the nodes include lower hidden layers to detect edges or textures (e.g., in an image classification task), while higher hidden layers might identify more abstract features like shapes or object parts.

The machine learning model in example 200 may be used for various tasks, including classification, prediction, or other latent concepts. Latent concepts are flexible and expressive and can be used to achieve more than what the original model was trained for. This is expressed in the form of “transfer learning” and “prompt engineering.” In these examples, the model may eventually collapse during the terminal phase of training into primitive “disentangled concepts,” which can be later recombined to produce a desired output (e.g., neural collapse).

Comparatively, in example 202, the machine learning model comprises input 205B (illustrated as an image of the classification), model portions 220, 225, filter 230, solver 235, ontology 240, output 250B (illustrated as a prediction of the classification), and explanation 260. In some examples, input 205B and output 250B correspond with input 205A and output 250A in example 200.

Model portions 220, 225 may be similar to hidden nodes 210, 215 in example 200, yet may be configured to implement the hidden portion of the model in two or more composable/modular parts. For example, a first model portion 220 may define the requirements of model in first order logic. The requirements of the model may be added to the specification of the classification objective. A second model portion 225 may be a neural networks, a recursive combination of neural networks, or other symbolic AI methods. In some examples, the second portion of model 225 may provide grounded symbols to the first portion of model 220. In these examples, the monolithic model may be partitioned into “usable disentangled” portions (e.g., layers at which neural collapse occurs). The disentangled concepts form the set of grounded symbols that can be used to generate the ontology that will produces the final output of the model. The reconstituted model, in some examples, can be created from a hybrid of an ontology and neural network.

In example 202, input 205B is received by the machine learning model that processes the input via model portions 220, 225. Output of model portions 220, 225 is received by filter 230, then passed to solver 235. Solver 235 accesses ontology 240 to identify the features and structural constraints of a particular classification. Solver 235, with the features that are described in ontology 240, determines the superclass corresponding with the ontology that aligns with the features. The identification of the superclass may be provided as output 250B with an explanation 260 (e.g., why the features of the input correspond with the identified superclass). Then, from the superclass, the system identifies trained neural networks or other models that are able to identify these features in new images.

Once the system receives the new input, the system can provide the new input to the trained neural network to identify the features in the new input. The process, in some examples, may essentially proceed backwards from the process described above, where the neural network identifies the features in the input, then the identified features correspond with the structural constraints (e.g., by ontology 240) for a superclass (e.g., by solver 235). In response to the system determining the superclass from the new input, the system may provide the identification of the superclass as output 250B with an explanation 260 to create the identification of the prediction output with the correlations.

In some examples, the forward/backward concept that incorporates the solver, filter, ontology, and other components discussed herein may implement a constructing phase and an inference phase of a classification process implemented by a machine learning model. For example, the constructing phase of the classification process may first generate the ontology (e.g., by ontology module 106 in FIG. 1) that identifies a set of features and corresponding structural constraints of the features. Using the ontology, the constructing phase may determine a superclass given the set of features and corresponding structural constraints in the ontology (e.g., by solver module 108 in FIG. 1). The constructing phase may also identify a machine learning model that is trained in identifying the set of features in a new input image (e.g., by machine learning module 112 in FIG. 1).

During the inference phase, a new input image may be received provided to the machine learning model for generating an output (e.g., by input module 114 in FIG. 1). The inference phase may provide the output of the ML model to a filter that identifies second features in the output (e.g., by filter module 110 in FIG. 1) and the second features may be provided to the solver associated with the constructing phase of the classification process (e.g., by solver module 108 in FIG. 1). Using the solver, the second features may be compared with the set of features and corresponding structural constraints that are required by the ontology. Based on the comparison, the inference process may determine that the new input image corresponds with the superclass. The system may further provide a textual explanation of the superclass to an interface of the computer system (e.g., by explanation module 116 in FIG. 1) based on the constructing phase and the inference phase.

FIG. 3 illustrates a correlation between a specification and ontology, in accordance with some examples described herein. In example 300, an illustrative example of an ontology showing features and corresponding structural constraints of the features. The ontology is a knowledge definition that identifies relationships between data in the form of features or symbols. In the illustrative example below, the symbols are facial features (e.g., skin, nose, eyes, and mouth) that define a knowledge definition of a face. The ontology defines the first order logic which will be built to the classification objective (e.g., the original model's output/prediction).

For example, an ontology may be generated to satisfy the first specification and derive the set of symbols. The set of symbols of the second set of specifications corresponding to the models and the models are trained or built for classification tasks.

The ML model can be executed to extract symbols from data. In some examples, the system may implement perception models based on the applicability of the model to the classification task. In this example, the classification task is face detection. The ML model (e.g., various face “feature” detection models) are chosen as model candidates. After selecting the candidate models, the system may pre-process the perceived symbols by applying filters to the symbols. The filters may be applied based on attributes of the symbols, like a prediction accuracy, to improve robustness of the perceived symbols.

As a first level, the system may filter symbols that are not relevant to with respect to ontology. In the face detection classification task, if the ontology needs only eyes, nose, and mouth as grounded symbols and if the model perceives hair, hat, clothes, and other symbols along with the needed symbols, the system may filter of the unwanted symbols before providing the input image to a selection process.

In some examples, the ontology may receive Boolean inputs. If the candidate model utilize a confidence value for each of the perceived symbols, the system may convert the confidence values into a Boolean value. For example, if the perception model predicts a “nose” with 0.7 confidence value, the system may implement a threshold value of 0.6 and present the present the symbol “nose” to the ontology with the input. On the other hand, if the confidence value was 0.55, the system may identify that the symbol is not present in the input. The threshold value may act as the second level filter to ensure features that have a high degree of confidence are used for reasoning.

In another illustrative example, an input image may illustrate a face, but components of the face may be occluded. For example, the input may comprise a side facing face that exposes a part of the nose or lips and only one eye instead of two eyes. The first ontology that defines a face with two eyes may not correspond with the input image, so the system may reject the machine learning model that corresponds with that particular ontology. However, a second ontology may correspond with the partial face and that ontology may be used in generating the final output and explanation (e.g., a right side of a face that is partially occluded like where the hair is falling on the eyebrow).

Using the process described herein, an illustrative example is provided where the input image includes a face. The face may include a region in the picture which is of a uniform color (e.g., skin) and a background (e.g., distinct in coloring and texture from the skin) that is separated by a boundary. Each of these components may be included with the specification/ontology corresponding with a definition of a face.

In furtherance of the example, the specification/ontology may detect additional features. For example, in the region of the face that occupies XY coordinates of the image, the system may identify another feature called an “eye” and count the number of eyes (e.g., two total) and locations relative to each other (e.g., left eye and right eye) that are found mostly most likely in the same XY axis. The system may identify another feature called a “nose” with coordinates relative to the identified eye features. Similar inference processes can be implemented for other features that are defined in the specification/ontology, lips, ears, hair, and other things. Once each of the features have been identified, the system may conclude that a face (corresponding with the specification/ontology) is found, which includes eyes, nose, ears, lips, and so on.

The system may also define subclasses. Continuing with the illustrative example, the system may detect no hair in the image, where the subclasses of “face” comprise “hair” and “bald” faces. A perception model identified by the system may correspond with detecting a “bald” type of face, which further distinguishes a face with a hat, if the hair is overlapping the left region of the face where the left eye should have been, whether the face is occluded with hair falling on top of the eyes, and so on. Additional subclass models may be included with the “bald” subclass, including nose, eyes, and the like.

It should be noted that the terms “optimize,” “optimal” and the like as used herein can be used to mean making or achieving performance as effective or perfect as possible. However, as one of ordinary skill in the art reading this document will recognize, perfection cannot always be achieved. Accordingly, these terms can also encompass making or achieving performance as good or effective as possible or practical under the given circumstances, or making or achieving performance better than that which can be achieved with other settings or parameters.

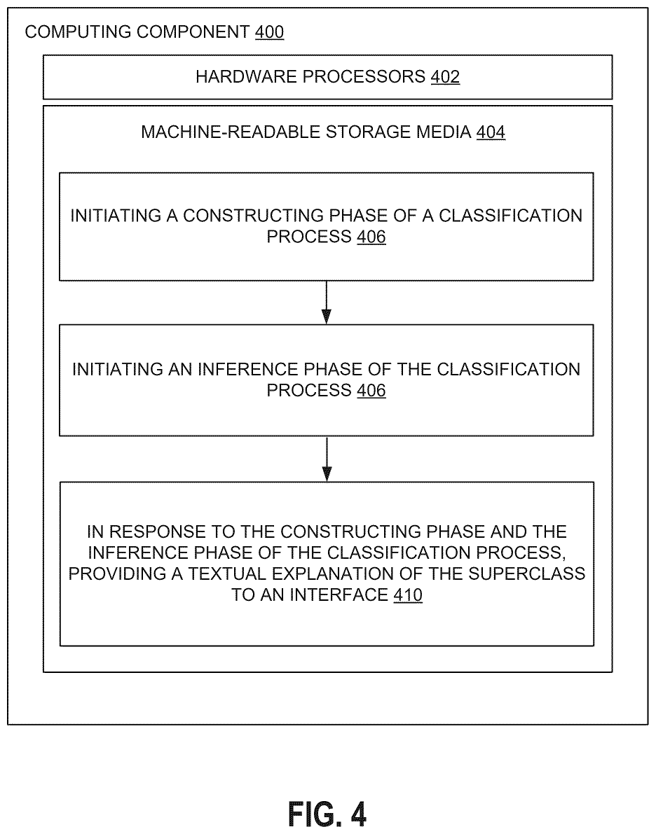

FIG. 4 illustrates a computing component that may be used to implement modular machine learning models, in accordance with various examples of the disclosed technology. Referring now to FIG. 4, computing component 400 may be, for example, a server computer, a controller, or any other similar computing component capable of processing data. In the example implementation of FIG. 4, the computing component 400 includes hardware processor 402 and machine-readable storage medium 404.

Hardware processor 402 may be one or more central processing units (CPUs), graphics processing units (GPUs), semiconductor-based microprocessors, and/or other hardware devices suitable for retrieval and execution of instructions stored in machine-readable storage medium 404. Hardware processor 402 may fetch, decode, and execute instructions, such as instructions 406-410, to control processes or operations for modular machine learning models. As an alternative or in addition to retrieving and executing instructions, hardware processor 402 may include one or more electronic circuits that include electronic components for performing the functionality of one or more instructions, such as a field programmable gate array (FPGA), application specific integrated circuit (ASIC), or other electronic circuits.

A machine-readable storage medium, such as machine-readable storage medium 404, may be any electronic, magnetic, optical, or other physical storage device that contains or stores executable instructions. Thus, machine-readable storage medium 404 may be, for example, Random Access Memory (RAM), non-volatile RAM (NVRAM), an Electrically Erasable Programmable Read-Only Memory (EEPROM), a storage device, an optical disc, and the like. In some examples, machine-readable storage medium 404 may be a non-transitory storage medium, where the term “non-transitory” does not encompass transitory propagating signals. As described in detail below, machine-readable storage medium 404 may be encoded with executable instructions, for example, instructions 406-410.

Hardware processor 402 may execute instruction 406 to initiate a constructing phase of a classification process. During the constructing phase, the system may generate an ontology that identifies features and corresponding structural constraints of the features. The ontology can identify a set of features and corresponding structural constraints of the features.

In some examples, the ontology is implemented during the constructing phase using a reasoner. The reasoner may help to produce verifiable proof of the model's classifications.

In some examples, the constructing phase comprises determining, by a solver, a superclass given the set of features and corresponding structural constraints in the ontology. In some examples, the solver receives the ontology as input and generates a textual/description statement or world view using description logic. The description logic may comprise various formats, including general, spatial, temporal, spatiotemporal, and fuzzy description logics, and each description logic is a different balance between expressive power and reasoning complexity by supporting different sets of mathematical constructors. In this example, the solver may review the symbols defined in the ontology and determine whether any deductions can be made, with the goal of providing the level/detail of the predictions that could have been generated from the full set of features.

In some examples, the constructing phase comprises identifying a machine learning model that is trained in identifying the set of features in a new input image. In some examples, pre-trained neural networks or other machine learning models may be selected during the constructing phase to extract the particular symbols defined in the ontology. The models may be trained to detect/extract the particular symbol from the input. The extracted symbols may be used by the reasoners or solver later in the process (e.g., during the inference/prediction phase) to detect the symbols in new input/images.

Hardware processor 402 may execute instruction 408 to initiate an inference phase of the classification process. During the inference/prediction phase, the new input image is received and passed to the identified neural networks or other machine learning models to generate an output from each model. The output from each model is provided to a filter that identifies the features in each output. In some examples, the inference phase of the classification process comprises providing the output to a filter that identifies second features in the output.

In some examples, the inference phase of the classification process comprises providing the second features to the solver associated with the constructing phase of the classification process. The solver compares the features identified in the input with the features and corresponding structural constraints of the features that are required by the ontology (e.g., a particular superclass needs three features, are the features and structural constraints identified?). In some examples, the inference phase of the classification process comprises determining that the new input image corresponds with the superclass. The new input image is determined to be part of the superclass based on the comparison.

Hardware processor 402 may execute instruction 410 to provide a textual explanation of the superclass to the interface. In some examples, the textual explanation is provided in response to the constructing phase and the inference phase.

The output can include an explanation of the prediction. The explanation can be generated by a reasoner engine to produce verifiable proof of the model's classifications (e.g., OWL 2 Reasoner, HermiT, FaCT++, Pellet, etc.). For example, the reasoner engine can generate textual explanations for the output and provide an explainability for the model. In some examples, the explanation can provide an identification of the superclass, explain why the input corresponds with the superclass, identify any features that are missing in order for the input to correspond with the superclass, and provide the explanation and input to a display/interface.

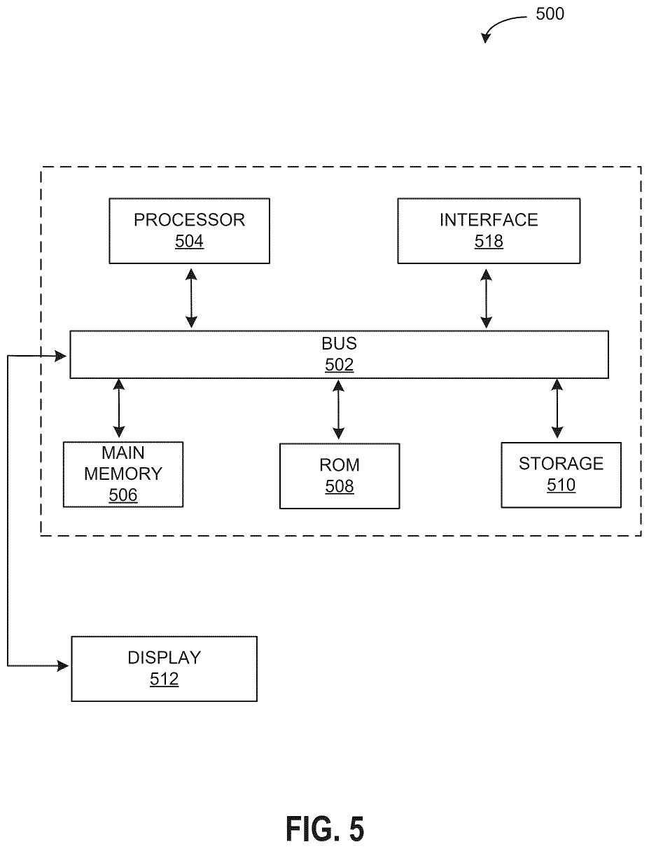

FIG. 5 depicts a block diagram of an example computer system 500 in which various examples of the disclosed technology described herein may be implemented. Computer system 500 includes bus 502 or other communication mechanism for communicating information, one or more hardware processors 504 coupled with bus 502 for processing information. Hardware processor(s) 504 may be, for example, one or more general purpose microprocessors.

Computer system 500 also includes main memory 506, such as a random access memory (RAM), cache and/or other dynamic storage devices, coupled to bus 502 for storing information and instructions to be executed by processor 504. Main memory 506 also may be used for storing temporary variables or other intermediate information during execution of instructions to be executed by processor 504. Such instructions, when stored in storage media accessible to processor 504, render computer system 500 into a special-purpose machine that is customized to perform the operations specified in the instructions.

Computer system 500 further includes read only memory (ROM) 508 or other static storage device coupled to bus 502 for storing static information and instructions for processor 504. Storage device 510, such as a magnetic disk, optical disk, or USB thumb drive (Flash drive), etc., is provided and coupled to bus 502 for storing information and instructions.

Computer system 500 may be coupled via bus 502 to display 512, such as a liquid crystal display (LCD) (or touch screen), for displaying information to a computer user. The information may include, for example, explainability of the machine learning model.

Computer system 500 may include a user interface module to implement a GUI to provide to display 512. The user interface module may be stored in a mass storage device as executable software codes that are executed by the computing device(s). This and other modules may include, by way of example, components, such as software components, object-oriented software components, class components and task components, processes, functions, attributes, procedures, subroutines, segments of program code, drivers, firmware, microcode, circuitry, data, databases, data structures, tables, arrays, and variables.

In general, the word “component,” “engine,” “system,” “database,” data store,” and the like, as used herein, can refer to logic embodied in hardware or firmware, or to a collection of software instructions, possibly having entry and exit points, written in a programming language, such as, for example, Java, C or C++. A software component may be compiled and linked into an executable program, installed in a dynamic link library, or may be written in an interpreted programming language such as, for example, BASIC, Perl, or Python. It will be appreciated that software components may be callable from other components or from themselves, and/or may be invoked in response to detected events or interrupts. Software components configured for execution on computing devices may be provided on a computer readable medium, such as a compact disc, digital video disc, flash drive, magnetic disc, or any other tangible medium, or as a digital download (and may be originally stored in a compressed or installable format that requires installation, decompression or decryption prior to execution). Such software code may be stored, partially or fully, on a memory device of the executing computing device, for execution by the computing device. Software instructions may be embedded in firmware, such as an EPROM. It will be further appreciated that hardware components may be comprised of connected logic units, such as gates and flip-flops, and/or may be comprised of programmable units, such as programmable gate arrays or processors.

Computer system 500 may implement the techniques described herein using customized hard-wired logic, one or more ASICs or FPGAs, firmware and/or program logic which in combination with the computer system causes or programs computer system 500 to be a special-purpose machine. According to one example of the disclosed technology, the techniques herein are performed by computer system 500 in response to processor(s) 504 executing one or more sequences of one or more instructions contained in main memory 506. Such instructions may be read into main memory 506 from another storage medium, such as storage device 510. Execution of the sequences of instructions contained in main memory 506 causes processor(s) 504 to perform the process steps described herein. In alternative examples, hard-wired circuitry may be used in place of or in combination with software instructions.

The term “non-transitory media,” and similar terms, as used herein refers to any media that store data and/or instructions that cause a machine to operate in a specific fashion. Such non-transitory media may comprise non-volatile media and/or volatile media. Non-volatile media includes, for example, optical or magnetic disks, such as storage device 510. Volatile media includes dynamic memory, such as main memory 506. Common forms of non-transitory media include, for example, a floppy disk, a flexible disk, hard disk, solid state drive, magnetic tape, or any other magnetic data storage medium, a CD-ROM, any other optical data storage medium, any physical medium with patterns of holes, a RAM, a PROM, and EPROM, a FLASH-EPROM, NVRAM, any other memory chip or cartridge, and networked versions of the same.

Non-transitory media is distinct from but may be used in conjunction with transmission media. Transmission media participates in transferring information between non-transitory media. For example, transmission media includes coaxial cables, copper wire and fiber optics, including the wires that comprise bus 502. Transmission media can also take the form of acoustic or light waves, such as those generated during radio-wave and infra-red data communications.

Computer system 500 also includes interface 518 coupled to bus 502. Interface 518 provides a two-way data communication coupling to one or more network links that are connected to one or more local networks. For example, interface 518 may be an integrated services digital network (ISDN) card, cable modem, satellite modem, or a modem to provide a data communication connection to a corresponding type of telephone line. As another example, interface 518 may be a local area network (LAN) card to provide a data communication connection to a compatible LAN (or WAN component to communicate with a WAN). Wireless links may also be implemented. In any such implementation, interface 518 sends and receives electrical, electromagnetic or optical signals that carry digital data streams representing various types of information.

A network link typically provides data communication through one or more networks to other data devices. For example, a network link may provide a connection through local network to a host computer or to data equipment operated by an Internet Service Provider (ISP). The ISP in turn provides data communication services through the world wide packet data communication network now commonly referred to as the “Internet.” Local network and Internet both use electrical, electromagnetic or optical signals that carry digital data streams. The signals through the various networks and the signals on network link and through interface 518, which carry the digital data to and from computer system 500, are example forms of transmission media.

Computer system 500 can send messages and receive data, including program code, through the network(s), network link and interface 518. In the Internet example, a server might transmit a requested code for an application program through the Internet, the ISP, the local network and interface 518.

The received code may be executed by processor 504 as it is received, and/or stored in storage device 510, or other non-volatile storage for later execution.

Each of the processes, methods, and algorithms described in the preceding sections may be embodied in, and fully or partially automated by, code components executed by one or more computer systems or computer processors comprising computer hardware. The one or more computer systems or computer processors may also operate to support performance of the relevant operations in a “cloud computing” environment or as a “software as a service” (SaaS). The processes and algorithms may be implemented partially or wholly in application-specific circuitry. The various features and processes described above may be used independently of one another, or may be combined in various ways. Different combinations and sub-combinations are intended to fall within the scope of this disclosure, and certain method or process blocks may be omitted in some implementations. The methods and processes described herein are also not limited to any particular sequence, and the blocks or states relating thereto can be performed in other sequences that are appropriate, or may be performed in parallel, or in some other manner. Blocks or states may be added to or removed from the disclosed examples. The performance of certain of the operations or processes may be distributed among computer systems or computers processors, not only residing within a single machine, but deployed across a number of machines.

As used herein, a circuit might be implemented utilizing any form of hardware, software, or a combination thereof. For example, one or more processors, controllers, ASICs, PLAs, PALs, CPLDs, FPGAs, logical components, software routines or other mechanisms might be implemented to make up a circuit. In implementation, the various circuits described herein might be implemented as discrete circuits or the functions and features described can be shared in part or in total among one or more circuits. Even though various features or elements of functionality may be individually described or claimed as separate circuits, these features and functionality can be shared among one or more common circuits, and such description shall not require or imply that separate circuits are required to implement such features or functionality. Where a circuit is implemented in whole or in part using software, such software can be implemented to operate with a computing or processing system capable of carrying out the functionality described with respect thereto, such as computer system 500.

As used herein, the term “or” may be construed in either an inclusive or exclusive sense. Moreover, the description of resources, operations, or structures in the singular shall not be read to exclude the plural. Conditional language, such as, among others, “can,” “could,” “might,” or “may,” unless specifically stated otherwise, or otherwise understood within the context as used, is generally intended to convey that certain examples include, while other examples do not include, certain features, elements and/or steps.

Terms and phrases used in this document, and variations thereof, unless otherwise expressly stated, should be construed as open ended as opposed to limiting. Adjectives such as “conventional,” “traditional,” “normal,” “standard,” “known,” and terms of similar meaning should not be construed as limiting the item described to a given time period or to an item available as of a given time, but instead should be read to encompass conventional, traditional, normal, or standard technologies that may be available or known now or at any time in the future. The presence of broadening words and phrases such as “one or more,” “at least,” “but not limited to” or other like phrases in some instances shall not be read to mean that the narrower case is intended or required in instances where such broadening phrases may be absent.

What is claimed is:

1. A computer-implemented method comprising:
initiating, by a computer system, a constructing phase of a classification process comprising:
generating an ontology that identifies a set of features and corresponding structural constraints of the features;
determining, by a solver, a superclass given the set of features and corresponding structural constraints in the ontology; and
identifying a machine learning model that is trained in identifying the set of features in a new input image; and
initiating, by the computer system, an inference phase of the classification process comprising:
receiving the new input image;
in response to receiving the new input image, providing the new input image to the machine learning model for generating an output;
providing the output to a filter that identifies second features in the output;
providing the second features to the solver associated with the constructing phase of the classification process;
comparing, using the solver, the second features with the set of features and corresponding structural constraints that are required by the ontology; and
based on the comparison, determining that the new input image corresponds with the superclass; and
in response to the constructing phase and the inference phase of the classification process, providing a textual explanation of the superclass to an interface of the computer system.

2. The computer-implemented method of claim 1, wherein the textual explanation is generated by an explainer module of the computer system.

3. The computer-implemented method of claim 1, wherein the textual explanation comprises an identification of the superclass and an explanation why the new input image corresponds with the superclass.

4. The computer-implemented method of claim 1, wherein the textual explanation comprises an identification of features that are missing in order for the new input image to correspond with a second superclass.

5. The computer-implemented method of claim 1, wherein the machine learning model is a pre-existing model comprising an input layer and a subset of hidden layers that previously completed a second constructing phase of the classification process.

6. The computer-implemented method of claim 1, wherein the machine learning model is a deep neural network (DNN).

7. The computer-implemented method of claim 1, wherein the set of features and corresponding structural constraints in the ontology are encoded from a specification that defines nodes and relationships between a set of prediction values.

8. A computer system comprising:
a memory storing instructions; and
a processor communicatively coupled to the memory and configured to execute the instructions to:
generate an ontology that identifies a set of features and corresponding structural constraints of the features;
determine a superclass given the set of features and corresponding structural constraints in the ontology;
initiate an inference phase of a classification process comprising:
receiving a new input image;
in response to receiving the new input image, providing the new input image to the classification process for generating an output;
providing the output to a filter that identifies second features in the output;
providing the second features to a solver of the classification process;
comparing, using the solver, the second features with the set of features and corresponding structural constraints that are required by the ontology; and
based on the comparison, determining that the new input image corresponds with the superclass; and
in response to the inference phase of the classification process, providing a textual explanation of the superclass to an interface of the computer system.

9. The computer system of claim 8, wherein the textual explanation is generated by an explainer module of the computer system.

10. The computer system of claim 8, wherein the textual explanation comprises an identification of the superclass and an explanation why the new input image corresponds with the superclass.

11. The computer system of claim 8, wherein the textual explanation comprises an identification of features that are missing in order for the new input image to correspond with a second superclass.

12. The computer system of claim 8, wherein the classification process is a pre-existing machine learning model comprising an input layer and a subset of hidden layers that previously completed a constructing process.

13. The computer system of claim 8, wherein the classification process is a deep neural network (DNN).

14. The computer system of claim 8, wherein the set of features and corresponding structural constraints in the ontology are encoded from a specification that defines nodes and relationships between a set of prediction values.

15. A non-transitory computer-readable storage medium storing a plurality of instructions executable by a processor, the plurality of instructions when executed by the processor cause the processor to:
initiate construction of a machine learning model comprising:
generating an ontology that identifies a set of features and corresponding structural constraints of the features;
determining, by a solver, a superclass given the set of features and corresponding structural constraints in the ontology; and
identifying the machine learning model that is trained in identifying the set of features in a new input image; and
initiate an inference phase of the machine learning model comprising:
receiving the new input image;
in response to receiving the new input image, providing the new input image to the machine learning model for generating an output;
providing the output to a filter that identifies second features in the output;
providing the second features to the solver;
comparing, using the solver, the second features with the set of features and corresponding structural constraints that are required by the ontology; and
based on the comparison, determining that the new input image corresponds with the superclass; and
in response to the inference phase, provide a textual explanation of the superclass to an interface.

16. The non-transitory computer-readable storage medium of claim 15, wherein the textual explanation is generated by an explainer module.

17. The non-transitory computer-readable storage medium of claim 15, wherein the textual explanation comprises an identification of the superclass and an explanation why the new input image corresponds with the superclass.

18. The non-transitory computer-readable storage medium of claim 15, wherein the textual explanation comprises an identification of features that are missing in order for the new input image to correspond with a second superclass.

19. The non-transitory computer-readable storage medium of claim 15, wherein the machine learning model is a pre-existing model comprising an input layer and a subset of hidden layers that previously completed a constructing process.

20. The non-transitory computer-readable storage medium of claim 15, wherein the machine learning model is a deep neural network (DNN).
